(19) United States
(12) Patent Application Publication
(10) Pub. No.: US 2020/0104140 A1
(43) Pub. Date: Apr. 2, 2020

(54) SYSTEMS AND METHODS FOR IDENTIFYING AND PROTECTION OF BOOT STORAGE DEVICES

(71) Applicant: Dell Products L.P., Round Rock, TX (US)

(72) Inventors: Wei G. LIU, Austin, TX (US); Chandrashekara Lingaiah NAGARATNA, Austin, TX (US); Kumaran Palaniappan THANGAVELU, Austin, TX (US); Sanjeev S. DAMBAL, Austin, TX (US)

(73) Assignee: Dell Products L.P., Round Rock, TX (US)

(21) Appl. No.: 16/149,853

(22) Filed: Oct. 2, 2018

(51) Int. Cl. G06F 9/4401; G06F 3/06

(52) U.S. Cl. CPC G06F 9/4408; G06F 9/4411; G06F 3/0664; G06F 3/0604; G06F 3/0629

(57) ABSTRACT

A method may be provided for use in an information handling system comprising a processor, one or more storage resources communicatively coupled to the processor, and a basic input/output system (BIOS) comprising a program of instructions executable by the processor and configured to cause the processor to initialize one or more information handling resources of the information handling system, the BIOS further configured to determine identities of each of the one or more storage resources and which of the one or more storage resources comprises a bootable operating system. The method may include receiving information regarding identities of each of the one or more storage resources and which of the one or more storage resources comprises a bootable operating system and communicating via the one or more management interfaces an alert indicating which of the one or more storage resources comprises the bootable operating system.

### TECHNICAL FIELD

The present disclosure relates in general to information handling systems, and more particularly to identifying and protecting boot storage resources in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of storage resources, such as a Redundant Array of Independent Disks (RAID), for example, for storing information. Arrays of storage resources typically utilize multiple disks to perform input and output operations and can be structured to provide redundancy which may increase fault tolerance. Other advantages of arrays of storage resources may be increased data integrity, throughput and/or capacity. In operation, one or more storage resources disposed in an array of storage resources may appear to an operating system as a single logical storage unit or “virtual storage resource.” Implementations of storage resource arrays can range from a few storage resources disposed in a server chassis, to hundreds of storage resources disposed in one or more separate storage enclosures.

Non-Volatile Memory Express (NVMe) solid state drives are increasingly becoming an industry norm for boot and data storage drives. The mix of storage drives in a system can include both boot storage drives and data storage drives. Properly identifying which storage drives are boot drives may be critical, as removal of a physical drive that stores an operating system or is part of a virtual storage resource that stored the operating system may lead to a system crash and/or other undesirable effects. In addition, traditional storage devices such as server-attached storage (SAS), RAID, and serial advanced technology attachment (SATA) which support hot-pluggability of storage resources may pose similar risks.

In addition, in traditional approaches, existing management software may not indicate if a virtual storage resource under a storage controller (e.g., a host bus adapter) has an operating system installed on it or not.

This could lead to a number of problems while managing a storage subsystem, including without limitation:

1. Accidental deletion of a virtual storage resource that has an operating system installed;

2. Removal of a boot drive before retiring or repurposing a server, preventing reuse of the drives and requiring operating system reinstallation;

3. Accidental removal of physical drives that are part of a virtual storage resource in which an operating system is stored; and

4. Operating information not available while deleting a boot virtual storage resource could lead to deletion of the wrong virtual storage resource.

### SUMMARY

In accordance with the teachings of the present disclosure, the disadvantages and problems associated with identifying and protecting boot storage resources may be reduced or eliminated.

In accordance with embodiments of the present disclosure, an information handling system may include a processor, one or more storage resources communicatively coupled to the processor, a basic input/output system (BIOS) comprising a program of instructions executable by the processor and configured to cause the processor to initialize one or more information handling resources of the information handling system, the BIOS further configured to determine identities of each of the one or more storage resources and which of the one or more storage resources comprises a bootable operating system, and a management controller communicatively coupled to the processor and configured to provide one or more management interfaces for management of the information handling system. The management controller may further be configured to receive information regarding identities of each of the one or more storage resources and which of the one or more storage resources comprises a bootable operating system and communicate via the one or more management interfaces an alert indicating which of the one or more storage resources comprises the bootable operating system.

In accordance with these and other embodiments of the present disclosure, a method may be provided for use in an information handling system comprising a processor, one or more storage resources communicatively coupled to the processor, and a basic input/output system (BIOS) comprising a program of instructions executable by the processor and configured to cause the processor to initialize one or more information handling resources of the information handling system, the BIOS further configured to determine identities of each of the one or more storage resources and which of the one or more storage resources comprises a bootable operating system. The method may include receiving information regarding identities of each of the one or more storage resources and which of the one or more storage resources comprises a bootable operating system and communicating via the one or more management interfaces an alert indicating which of the one or more storage resources comprises the bootable operating system.

In accordance with these and other embodiments of the present disclosure, an article of manufacture may include a non-transitory computer readable medium and computer-executable instructions carried on the computer readable medium, the instructions readable by a processor, the instructions, when read and executed, for causing the processor to, in an information handling system comprising a processor, one or more storage resources communicatively coupled to the processor, and a basic input/output system (BIOS) comprising a program of instructions executable by the processor and configured to cause the processor to initialize one or more information handling resources of the information handling system, the BIOS further configured to determine identities of each of the one or more storage resources and which of the one or more storage resources comprises a bootable operating system: receive information regarding identities of each of the one or more storage resources and which of the one or more storage resources comprises a bootable operating system, and communicate via the one or more management interfaces an alert indicating which of the one or more storage resources comprises the bootable operating system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow chart of an example method for identifying and protecting boot storage resources for storage controllers that include virtual storage resources, in accordance with embodiments of the present disclosure; and

FIG. 3 illustrates a flow chart of an example method for identifying and protecting boot storage resources for NVMe and SATA storage resources, in accordance with embodiments of the present disclosure.

### DETAILED DESCRIPTION

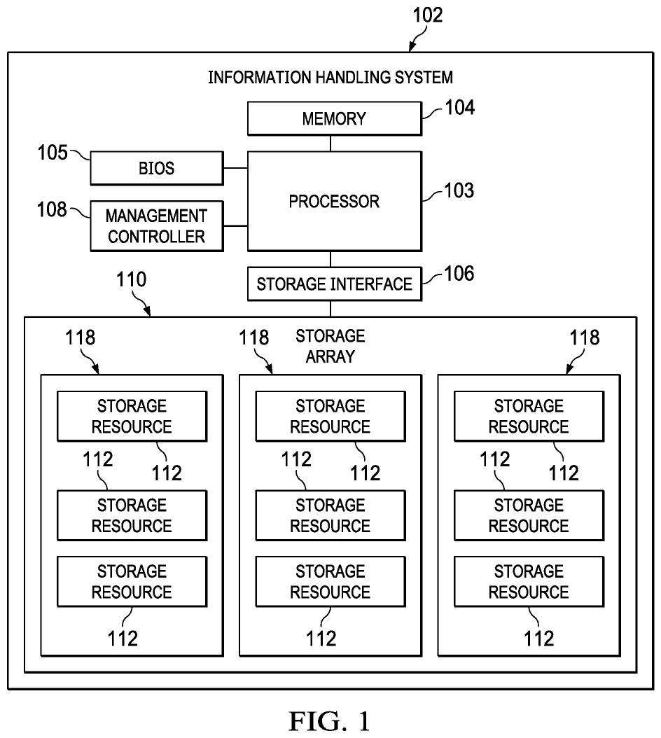

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example information handling system 102, in accordance with embodiments of the present disclosure. In some embodiments, information handling system 102 may comprise a server. In these and other embodiments, information handling system 102 may comprise a personal computer. In other embodiments, information handling system 102 may be a portable computing device (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a storage interface 106 communicatively coupled to processor 103, a management controller 108 communicatively coupled to processor 103, and a storage array 110 communicatively coupled to processor 103 via storage interface 106.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 105, storage array 110, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

Storage interface 106 may be communicatively coupled to processor 103 and may include any system, device, or apparatus configured to serve as an interface for communication between processor 103 and storage resources 112 of storage array 110 to facilitate communication of data between processor 103 and storage resources 112 in accordance with any suitable standard or protocol. In some embodiments, storage interface 106 may provide functionality including, without limitation, disk aggregation and redundancy (e.g., RAID), I/O routing, and error detection and recovery. Storage interface 106 may also have features supporting shared storage and high availability. In some embodiments, storage interface 106 may comprise a network interface configured to interface with storage resources 112 located remotely from information handling system 102. In these and other embodiments, storage interface 106 may comprise a storage controller (e.g., a RAID controller such as PowerEdge RAID Controller (PERC) manufactured by Dell Inc.). In other embodiments, such as when storage array 110 is implemented with physical storage devices 112 which are Peripheral Component Inteconnect Express (PCIe) storage devices or NVMe storage devices, many storage control functions may be implemented within the storage devices themselves, and storage interface 106 may comprise a PCIe bus for communication between processor 103 and storage array 110. In addition or alternatively, in some embodiments, some or all of the functionality of storage interface 106 may be implemented in software code executable on processor 103 (e.g., by a RAID driver).

Management controller 108 may be configured to provide out-of-band management facilities for management of information handling system 102. Such management may be made by management controller 108 even if information handling system 102 is powered off or powered to a standby state. Management controller 108 may include any suitable components for carrying out its functionality, including without limitation a processor, memory, and an out-of-band network interface separate from and physically isolated from an in-band network interface of information handling system 102. In certain embodiments, management controller 108 may include or may be an integral part of a baseboard management controller (BMC), a remote access controller (e.g., a Dell Remote Access Controller or Integrated Dell Remote Access Controller), or an enclosure controller. In other embodiments, management controller 108 may include or may be an integral part of a chassis management controller (CMC).

Storage array 110 may include a plurality of physical storage resources 112. Storage resources 112 may be disposed in one or more storage enclosures configured to hold and power storage resources 112. Storage resources 112 may include hard disk drives, magnetic tape libraries, optical disk drives, magneto-optical disk drives, compact disk drives, compact disk arrays, disk array controllers, NMVe storage resources, and/or any other system, apparatus or device operable to store media.

In operation, one or more storage resources 112 may appear to an operating system or virtual machine executing on information handling system 102 as a single logical storage unit or virtual storage resource 118. For example, each such virtual storage resource 118 may comprise a RAID. Thus, in some embodiments, a virtual storage resource 118 may comprise a redundant array of storage resources 112, wherein at least one of the storage resources 112 making up the virtual storage resource 118 enables data redundancy in order to avoid loss of data in the event of failure and/or removal of one of the storage resources making up the virtual storage resource. In the same or alternative embodiments, virtual storage resource 118 may be implemented using a RAID standard.

Although in the embodiment depicted in FIG. 1 each virtual storage resource 118 is shown as including three storage resources 112, it is understood that a virtual storage resource 118 may comprise any number of storage resources.

In addition to processor 103, memory 104, BIOS 105, storage interface 106, management controller 108, and storage array 110 of physical storage resources 112, information handling system 102 may include one or more other information handling resources.

In operation, management controller 108 and BIOS 105 may be configured to work in concert to determine which virtual storage resources 118 or physical storage resources 112 (e.g., in the case of NVMe or SATA) have an operating system installed thereon, and further configured to store such information in a configuration database of management controller 108, as a part of a system hardware inventory for information handling system 102 (e.g., as part of Collect System Inventory On Restart (CSIOR) functionality of an iDRAC).

On management controller 108, such system hardware inventory may include a property relating to virtual storage resources 118 (and physical storage resources 112 for NVMe and SATA), such property defining whether such virtual or physical storage resource has an operating system stored on it. Accordingly, an administrator of information handling system 102 may access the hardware inventory via any appropriate management interface (e.g., WesServices Management (WSMAN), Remote Access Controller Administrator (RACADM), iDRAC graphical user interface) to determine which virtual storage resources 118/physical storage resources 112 have an operating system stored thereon. In the event multiple virtual storage resources 118/physical storage resources 112 have an operating system image stored on them, the hardware inventory data stored by management controller 108 may also include a flag or other variable to indicate the operating system image from which information handling system 102 has booted. In addition or alternatively, management controller 108 may issue an alert to an administrator of information handling system 102 in the event the administrator or other user of information handling system 102 attempts to delete a virtual storage resource 118 and/or physical storage resource 112 having a boot operating handling system installed on it. In some embodiments, such alert may include causing a visual indicator (e.g., a light-emitting diode) present on physical storage resources 112 comprising the boot operating system or present on physical storage resources 112 making up a virtual storage resource 118 comprising the boot operating system to indicate (e.g., blink, display a particular color of light, etc.) the presence of a boot operating system in such physical storage resources 112. Thus, such indication may be used to warn a technician against removing one or more particular physical storage resources 112 during runtime operation, as a well as identifying one or more particular physical storage resources 112 to remove before retiring or repurposing information handling system 102.

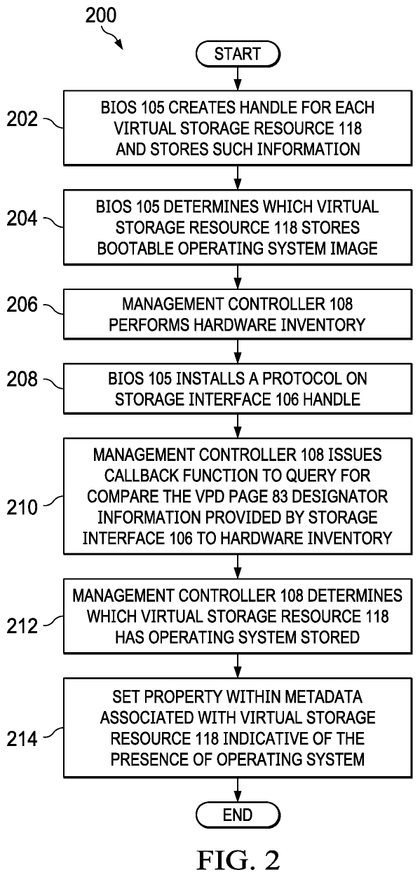

FIG. 2 illustrates a flow chart of an example method 200 for identifying and protecting boot storage resources for storage controllers that include virtual storage resources, in accordance with embodiments of the present disclosure. According to certain embodiments, method 200 may begin at step 202. As noted above, teachings of the present disclosure may be implemented in a variety of configurations of system 100 as shown in FIG. 1. As such, the preferred initialization point for method 200 and the order of the steps comprising method 200 may depend on the implementation chosen.

At step 202, information handling system 102 may boot and BIOS 105 may create a handle for each virtual storage resource 118 and store such information. For example, such information may be stored as Vital Product Data (VPD) at page 83 of VPD. Accordingly, BIOS 105 may have access to the VPD page 83 information of each virtual storage resource 118 which may include a unique designator identifier for the virtual storage resource 118. In addition, management controller 108 may obtain a list of virtual storage resources 118 from storage interface 106 and may also obtain the VPD page 83 information of each virtual storage resource 118.

At step 204, BIOS 105 may determine which virtual storage resource 118 stores a bootable operating system image. For example, in UEFI boot mode, whether a virtual storage resource 118 has an operating system loader or not can be determined by the presence of Efi\boot\BootX64.efi or Efi\boot\Bootmgr.efi on the drive itself. To find out which operating system loader that information handling system 102 is currently booted from, the boot option to which BIOS 105 last gives control may include the device path pointing to the bootable virtual storage resource 118. Some operating system boot options may include a short-formed device path, but such short-formed device path may be easily expanded to a full device path to uniquely identify the bootable virtual storage resource 118. In addition, in UEFI boot mode, an operating system type and operating system name might be derived from a boot option name string. For example, a Windows operating system may include a string such as “Windows Boot Manager.” On the other hand, in a legacy BIOS mode, there may not be a reliable way of telling whether a virtual storage resource 118 is bootable or not. However, BIOS 105 may still be able to determine which virtual storage resource 118 that operating handling system 102 attempted to boot. For example, the BIOS boot option in Dell's Compatibility Support Module (CSM) implementation may include a device path to the bootable storage resource 118, so that before BIOS 105 gives control to the master boot record (MBR) code of a particular boot option, BIOS 105 may set an appropriate flag indicative of the device path, and inform management controller 108 via communication channels such as Intelligent Platform Management Interface (IPMI) commands. Another way to obtain the operating system name string from which information handling system 102 boots is via the Advance Configuration and Power Interface Operating System Interfaces (ACPI_OSI) method. Using such method, BIOS 105 may obtain the operating system name string and pass such information to management controller 108 via an IPMI command.

At step 206, management controller 108 may perform a hardware inventory (e.g., CSIOR) of information handling system 102. Because CSIOR executes before BIOS 105 may have an opportunity to collect the virtual storage resource boot information, which can only be done at the time the boot options are enumerated and right before booting a boot option, the CSIOR code may have a callback that hooks on a BIOS ReadyToBoot event. Thus, at step 208, right before BIOS 105 gives control to a boot option, BIOS 105 may install a protocol (e.g., EFI_DELL_BOOTDISK_OS_PROTOCOL) on a storage interface 106 handle.

At step 210, the management controller callback function may query for a unique identifier (e.g., Designator_id) from the new protocol installed and for each unique identifier (e.g., Designator_id), compare the VPD page 83 designator information provided by storage interface 106. Thus, at step 212, management controller 108 may determine which virtual storage resource 118 has an operating system stored on it by determining when the unique identifier matches the page 83 designator information, and after determining such information, may, at step 214, set a property (e.g., an “OSlnstalled” property) within metadata (e.g., DCIM_VirtualDiskView) associated with the virtual storage resource 118 indicative of the presence of the operating system and copy the operating system name (if any) to a property (e.g., an “OSName” property) of the metadata (e.g., DCIM_VirtualDiskView). The following is an example of such a metadata file for a virtual storage resource 118 having a bootable operating system stored thereon:

BlockSizelnBytes=512

BusProtocol=6

Cachecade=0

DeviceDescription=Virtual Disk 0 on RAID Controller in Slot 4

DiskCachePolicy=256

FQDD=Disk.Virtual.0:RAID.Slot.4-1

InstanceID=Disk.Virtual.0:RAID.Slot.4-1

LastSystemInventoryTime=20171201083410.000000+000

LastUpdateTime=20171201083410.000000+000

LockStatus=0

MediaType=1

Name=Virtual Disk 0

ObjectStatus=0

OperationName=None

OperationPercentComplete=0

PendingOperations=0 PhysicalDiskIDs=Disk.Bay.4:Enclosure.Internal.0-1:RAID.Slot.4-1 PrimaryStatus=1

RAIDStatus=2

RAIDTypes=64

ReadCachePolicy=32

RemainingRedundancy=1

RollupStatus=1

SizelnBytes=71672266752

SpanDepth=1

SpanLength=3

StartingLBAinBlocks=0

StripeSize=512 T1OPI

Status=0

VirtualDiskTargetID=0

WriteCachePolicy=2

OSInstalled=1

OSName=Microsoft Windows 2016

After completion of step 214, method 200 may end.

Although FIG. 2 discloses a particular number of steps to be taken with respect to method 200, it may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 102, components thereof, or any other suitable system operable to implement method 200. In certain embodiments, method 200 may be implemented partially or fully in software and/or firmware embodied in computer-readable media.

For NVMe and SATA there is no VPD page 83 information, but the boot storage resource may be much easier to identify. The boot option device path may point all the way to the physical storage resource 112 itself. From the device path, the slot and bay identifier of the physical storage resource 112 may easily be identified. In addition, a protocol similar to that published in method 200 (e.g., EFI DELL BOOTDISK OS PROTOCOL) may be published by BIOS 105 for each physical storage resource 112. If NVMe/SATA physical storage resources 112 are managed by the software RAID drivers, BIOS 105 may define a protocol or EFI variable to retrieve boot drive information from such software drivers.

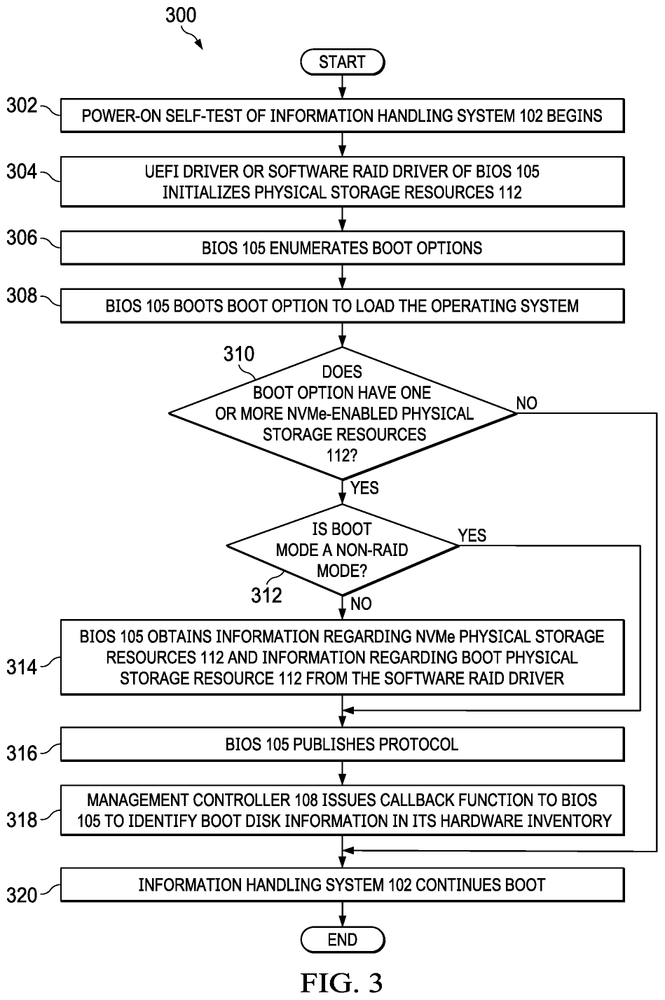

FIG. 3 illustrates a flow chart of an example method 300 for identifying and protecting boot storage resources for NVMe and SATA storage resources, in accordance with embodiments of the present disclosure. According to certain embodiments, method 300 may begin at step 302. As noted above, teachings of the present disclosure may be implemented in a variety of configurations of information handling system 102 as shown in FIG. 1. As such, the preferred initialization point for method 300 and the order of the steps comprising method 300 may depend on the implementation chosen.

At step 302, power-on self-test of information handling system 102 may begin. At step 304, a UEFI driver of BIOS 105 or a software RAID driver of BIOS 105 may initialize physical storage resources 112. At step 306, BIOS 105 may enumerate boot options. At step 308, BIOS 105 may boot a boot option in order to load the operating system. At step 310, BIOS 105 may determine if the boot option is one or more of NVMe-enabled physical storage resources 112. If the boot option is one or more of NVMe-enabled physical storage resources 112, method 300 may proceed to step 310. Otherwise, method 300 may proceed to step 320.

At step 312, BIOS 105 may determine if the boot mode is a non-RAID mode. If the boot mode is not a non-RAID mode, method 300 may proceed to step 314. Otherwise, method 300 may proceed to step 316.

At step 314, responsive to a determination that the boot mode is not a non-RAID mode, BIOS 105 may obtain information regarding NMVe physical storage resources 112 from a software RAID driver and obtain information regarding the boot physical storage resource 112 from the software RAID driver.

At step 316, BIOS 105 may publish a protocol (e.g., EFI_DELL_BOOTDISK_OS_PROTOCOL). At step 318, management controller 108 may issue a callback function to BIOS 105 to identify the boot disk information in its hardware inventory.

At step 320, information handling system 102 may continue boot.

Although FIG. 3 discloses a particular number of steps to be taken with respect to method 300, it may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using information handling system 102, components thereof, or any other suitable system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above. Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
one or more storage resources communicatively coupled to the processor;
a basic input/output system (BIOS) comprising a program of instructions executable by the processor and configured to cause the processor to initialize one or more information handling resources of the information handling system, the BIOS further configured to determine identities of each of the one or more storage resources and which of the one or more storage resources comprises a bootable operating system; and
a management controller communicatively coupled to the processor and configured to provide one or more management interfaces for management of the information handling system, and further configured to:
receive information regarding identities of each of the one or more storage resources and which of the one or more storage resources comprises a bootable operating system; and
communicate via the one or more management interfaces an alert indicating which of the one or more storage resources comprises the bootable operating system.

2. The information handling system of claim 1, wherein the alert comprises an indication by a visual indicator associated with a storage resource indicating the storage resource comprises the bootable operating system or is within a virtual storage resource comprising the bootable operating system.

3. The information handling system of claim 1, wherein the alert comprises communication of information regarding the one or more storage resources comprising the bootable operating system to a management interface.

4. The information handling system of claim 1, wherein the management controller is configured to receive information from the BIOS regarding identities of each of the one or more storage resources and which of the one or more storage resources comprises the bootable operating system.

5. The information handling system of claim 1, further comprising a storage interface for controlling the one or more storage resources, wherein:
the storage interface receives information from the BIOS regarding identities of each of the one or more storage resources;
the management controller receives information from the storage interface regarding identities of each of the one or more storage resources; and
the management controller receives information from the BIOS regarding which of the one or more storage resources comprises the bootable operating system.

6. A method comprising, in an information handling system comprising a processor, one or more storage resources communicatively coupled to the processor, and a basic input/output system (BIOS) comprising a program of instructions executable by the processor and configured to cause the processor to initialize one or more information handling resources of the information handling system, the BIOS further configured to determine identities of each of the one or more storage resources and which of the one or more storage resources comprises a bootable operating system:
receiving information regarding identities of each of the one or more storage resources and which of the one or more storage resources comprises a bootable operating system; and
communicating via one or more management interfaces an alert indicating which of the one or more storage resources comprises the bootable operating system.

7. The method of claim 6, wherein the alert comprises an indication by a visual indicator associated with a storage resource indicating the storage resource comprises the bootable operating system or is within a virtual storage resource comprising the bootable operating system.

8. The method of claim 6, wherein the alert comprises communication of information regarding the one or more storage resources comprising the bootable operating system to the one or more management interfaces.

9. The method of claim 6, further comprising receiving information from the BIOS regarding identities of each of the one or more storage resources and which of the one or more storage resources comprises the bootable operating system.

10. The method of claim 6, further comprising:
receiving information from a storage interface configured to control the one or more storage resources regarding identities of each of the one or more storage resources; and
receiving information from the BIOS regarding which of the one or more storage resources comprises the bootable operating system;
wherein the storage interface receives information from the BIOS regarding identities of each of the one or more storage resources.

11. An article of manufacture comprising:
a non-transitory computer readable medium; and [symbol]
computer-executable instructions carried on the computer readable medium, the instructions readable by a processor, the instructions, when read and executed, for causing the processor to, in an information handling system comprising a processor, one or more storage resources communicatively coupled to the processor, and a basic input/output system (BIOS) comprising a program of instructions executable by the processor and configured to cause the processor to initialize one or more information handling resources of the information handling system, the BIOS further configured to determine identities of each of the one or more storage resources and which of the one or more storage resources comprises a bootable operating system:
receive information regarding identities of each of the one or more storage resources and which of the one or more storage resources comprises a bootable operating system; and
communicate via one or more management interfaces an alert indicating which of the one or more storage resources comprises the bootable operating system.

12. The article of claim 11, wherein the alert comprises an indication by a visual indicator associated with a storage resource indicating the storage resource comprises the bootable operating system or is within a virtual storage resource comprising the bootable operating system.

13. The article of claim 11, wherein the alert comprises communication of information regarding the one or more storage resources comprising the bootable operating system to the one or more management interfaces.

14. The article of claim 11, the instructions for further causing the processor to receive information from the BIOS regarding identities of each of the one or more storage resources and which of the one or more storage resources comprises the bootable operating system.

15. The article of claim 11, the instructions for further causing the processor to:
receive information from a storage interface configured to control the one or more storage resources regarding identities of each of the one or more storage resources; and
receive information from the BIOS regarding which of the one or more storage resources comprises the bootable operating system;
wherein the storage interface receives information from the BIOS regarding identities of each of the one or more storage resources.
